(19) United States
(12) Patent Application Publication
(10) Pub. No.: US 2016/0105412 A1
(43) Pub. Date: Apr. 14, 2016

(54) NETWORK CONNECTION METHOD, APPLICATION AUTHENTICATION SERVER, TERMINAL AND ROUTER

(71) Applicant: TENCENT TECHNOLOGY (SHENZHEN) COMPANY LIMITED, Shenzhen (CN)

(72) Inventors: Feilong SHEN, Shenzhen (CN); Fudong SHAO, Shenzhen (CN)

(21) Appl. No.: 14/971,865

(22) Filed: Dec. 16, 2015

Related U.S. Application Data
(63) Continuation of application No. PCT/CN2015/073526, filed on Mar. 2, 2015.

(30) Foreign Application Priority Data
Mar. 3, 2014 (CN) 201410075323.7

(51) Int. Cl. H04L 29/06; H04W 76/02; H04L 29/08

(52) U.S. Cl. CPC H04L 63/08; H04L 67/303; H04W 76/02; H04L 63/0876; H04W 84/12

(57) ABSTRACT

The present disclosure relates to the field of network technologies and discloses a network connection method, an application authentication server, a terminal and a router. The method includes: acquiring a first application account corresponding to a terminal and first router identification information received by the terminal; determining, according to the first application account and the first router identification information, whether the terminal has permission to connect to a network through a router; and returning, to the terminal if the terminal has permission to connect to the network through the router, authentication information of connecting to the network through the router, so that the terminal connects to the network through the router according to the authentication information.

### CROSS REFERENCE TO RELATED APPLICATIONS

This is a continuation application of International Patent Application No. PCT/CN2015/073526, filed on Mar. 2, 2015, which claims priority to Chinese Patent Application No. 201410075323.7 filed on Mar. 3, 2014, the disclosure of which is incorporated by reference herein in its entirety.

### FIELD OF THE TECHNOLOGY

The present disclosure relates to the field of network technologies, and in particular, to a network connection method, an application authentication server, a terminal and a router.

### BACKGROUND OF THE DISCLOSURE

With the development of network technologies, it becomes increasingly easier for a terminal to connect to a network. For example, with the development of the Wireless Fidelity (WiFi) technology, increasingly more terminals can connect to networks by means of WiFi. Generally, a terminal needs to connect to a network through a router, and before connecting the terminal to the network, an administrator of the router presets router identification information of the router and authentication information of connecting to the network through the router. The authentication information of the router may be a pre-shared key (PSK) or the like. Therefore, when connecting to the network, the terminal needs to acquire the router identification information of the router and a PSK corresponding to the router identification information, and connect to the network according to the obtained router identification information and the PSK corresponding to the router identification information.

Specifically, in the related art, when connecting to a network, the terminal provides a PSK text box when acquiring the PSK corresponding to the router identification information after receiving the router identification information. Therefore, acquiring of the PSK by the terminal is generally implemented by a corresponding user of the terminal by entering a PSK preset for the router by the administrator into the PSK text box.

However, because in the related art, when connecting to a network, acquiring of the PSK by the terminal is implemented by the user by entering the PSK preset for the router by the administrator into the PSK text box, the user needs to enter the correct PSK in order to ensure that the terminal can successfully connect to the network through the router. Because the operation of entering the PSK may be rather complex for the user, affecting user experience. Moreover, if the PSK entered by the user is not correct, the network connection fails, and in this case, the user has to enter the PSK again, resulting in low network connection efficiency.

### SUMMARY

To solve the problems of the related art, embodiments of the present invention provide a network connection method, an application authentication server, a terminal and a router. The technical solution are as follows:

In a first aspect, a network connection method is provided, including:

acquiring a first application account corresponding to a terminal and first router identification information received by the terminal, the first router identification information being sent by a router corresponding to the first router identification information;

determining, according to the first application account and the first router identification information, whether the terminal has permission to connect to a network through the router; and

returning, to the terminal if it is determined that the terminal has permission to connect to the network through the router, authentication information of connecting to the network through the router, so that the terminal connects to the network through the router according to the authentication information after receiving the authentication information.

In a second aspect, a network connection method is provided, including:

broadcasting a network connection request, so that a router receiving the network connection request returns first router identification information;

receiving the first router identification information, and acquiring a corresponding first application account;

submitting the first application account and the first router identification information to an application authentication server, so that the application authentication server authenticates, according to the first application account and the first router identification information, permission to connect to a network through the router, and after determining that the permission authentication succeeds, the application authentication server returns authentication information of connecting to the network through the router; and

receiving the authentication information, and connecting to the network through the router according to the authentication information.

In a third aspect, a network connection method is provided, including:

receiving a network connection request broadcast by a terminal; and

returning first router identification information to the terminal according to the network connection request, so that the terminal submits a first application account and the first router identification information received by the terminal to an application authentication server, receives authentication information that is returned by the application authentication server after determining according to the first application account and the first router identification information that the terminal has permission to connect to a network, and connects to the network according to the authentication information.

In a fourth aspect, an application authentication server is provided, including:

an acquiring module, configured to acquire a first application account corresponding to a terminal and first router identification information received by the terminal, the first router identification information being sent by a router corresponding to the first router identification information;

a determining module, configured to determine, according to the first application account and the first router identification information, whether the terminal has permission to connect to a network through the router; and

a returning module, configured to return, to the terminal when it is determined that the terminal has permission to connect to the network through the router, authentication information of connecting to the network through the router, so that the terminal connects to the network through the router according to the authentication information after receiving the authentication information.

In a fifth aspect, a terminal is provided, including:

a broadcast module, configured to broadcast a network connection request, so that a router receiving the network connection request returns first router identification information;

a first receiving module, configured to receive the first router identification information;

an acquiring module, configured to acquire a corresponding first application account;

a submission module, configured to submit the first application account and the first router identification information to an application authentication server, so that the application authentication server authenticates, according to the first application account and the first router identification information, permission to connect to a network through the router, and after determining that the permission authentication succeeds, the application authentication server returns authentication information of connecting to the network through the router; and

a second receiving module, configured to receive the authentication information; and

a connection module, configured to connect to the network through the router according to the authentication information.

In a sixth aspect, a router is provided, including:

a first receiving module, configured to receive a network connection request broadcast by a terminal; and

a first returning module, configured to return first router identification information to the terminal according to the network connection request, so that the terminal submits a first application account and the first router identification information received by the terminal to an application authentication server, receives authentication information that is returned by the application authentication server after determining according to the first application account and the first router identification information that the terminal has permission to connect to a network, and connects to the network according to the authentication information.

The technical solutions provided by the embodiments of the present invention have the following beneficial effects:

After it is determined, according to a first application account corresponding to a terminal and first router identification information received by the terminal, that the terminal has permission to connect to a network through a router, authentication information of connecting to the network through the router is directly returned to the terminal, so that the terminal can connect to the network according to the authentication information without the need for the user to input authentication information. This not only simplifies the network connection operation of the terminal, but also can improve the network connection efficiency of the terminal.

### BRIEF DESCRIPTION OF THE DRAWINGS

To describe the technical solutions of the embodiments of the present invention more clearly, the following briefly introduces the accompanying drawings required for describing the embodiments. Apparently, the accompanying drawings in the following description show only some embodiments of the present invention, and a person of ordinary skill in the art may still derive other drawings from these accompanying drawings without creative efforts.

FIG. 1 is a schematic structural diagram of an implementation environment of connecting to a network according to an embodiment of the present invention;

FIG. 2 is a flowchart of a network connection method according to Embodiment 1 of the present invention;

FIG. 3 is a flowchart of another network connection method according to Embodiment 1 of the present invention;

FIG. 4 is a flowchart of still another network connection method according to Embodiment 1 of the present invention;

FIG. 5 is a schematic structural diagram of a network connection method according to Embodiment 2 of the present invention;

FIG. 6 is a schematic structural diagram of an application authentication server according to Embodiment 3 of the present invention;

FIG. 7 is a schematic structural diagram of a terminal according to Embodiment 4 of the present invention;

FIG. 8 is a schematic structural diagram of a terminal according to Embodiment 5 of the present invention;

FIG. 9 is a schematic structural diagram of a router according to Embodiment 8 of the present invention; and

FIG. 10 is a schematic structural diagram of a network connection system according to Embodiment 9 of the present invention.

### DESCRIPTION OF EMBODIMENTS

To make the technical solutions and advantages of the present disclosure, implementation manners of the present disclosure will be described in further detail with reference to the accompanying drawings.

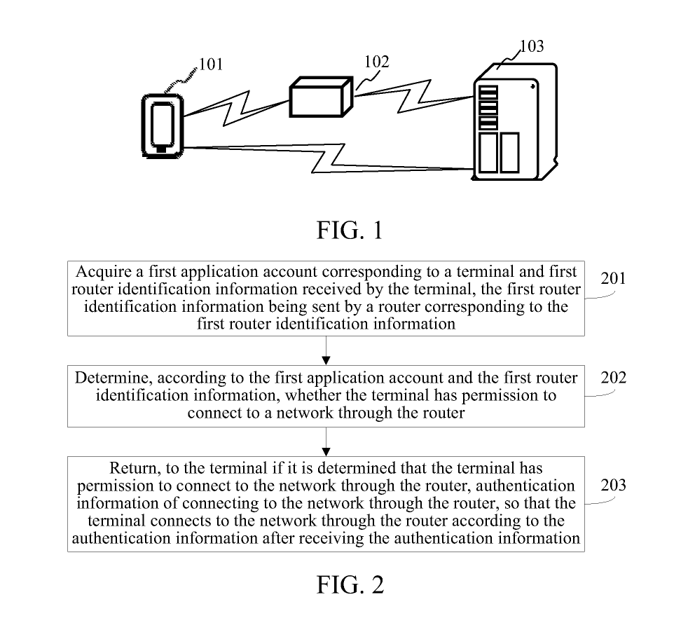

FIG. 1 is a schematic structural diagram of an implementation environment of a method according to an embodiment of the present invention. As shown in FIG. 1, the implementation environment includes an application authentication server 103, a terminal 101 and a router 102. Referring to FIG. 1, according to the method provided by this embodiment of the present invention, the terminal 101 can connect to a network through the router 102. In addition, authentication information of the router 102 that is required when the terminal 101 connects to the network is returned to the terminal 101 by the application authentication server 103 after determining that the terminal 101 has permission to connect to the network through the router 102. The method by which the terminal 101 connects to the network through the router 102 and the application authentication server 103 is not described here; for details, refer to Embodiment 1 and Embodiment 2 below.

The terminal 101 may be a smart phone, a tablet computer, an e-book reader, a Moving Picture Experts Group Audio Layer III (MP3) player, a Moving Picture Experts Group Audio Layer IV (MP4) player, a laptop portable computer, a desktop computer or the like. The application authentication server 103 may be any service having a particular function, including, but not limited to, a server corresponding to a instant messaging tool.

### Embodiment 1

With reference to the schematic diagram of the implementation environment shown in FIG. 1 and the content described above, this embodiment of the present invention provides a network connection method. For an example in which the method provided by this embodiment of the present invention is executed by an application authentication server, referring FIG. 2, the process of the method provided by this embodiment of the present invention includes:

201: Acquire a first application account corresponding to a terminal and first router identification information received by the terminal, the first router identification information being sent by a router corresponding to the first router identification information.

202: Determine, according to the first application account and the first router identification information, whether the terminal has permission to connect to a network through the router.

The determining, according to the first application account and the first router identification information, whether the terminal has permission to connect to a network through the router includes:

acquiring at least one second application account bound to the first router identification information;

determining, if at least one second application account bound to the first router identification information is obtained, whether the first application account is an application account managed by the at least one second application account bound to the first router identification information; and

determining that the terminal has permission to connect to the network through the router, if it is determined that the first application account is an application account managed by the at least one second application account bound to the first router identification information.

Preferably, before the acquiring at least one second application account bound to the first router identification information, the method further includes:

binding at least one piece of second router identification information to at least one second application account; and

the acquiring at least one second application account bound to the first router identification information comprises:

determining whether there is second router identification information identical to the first router identification information in the at least one piece of second router identification information; and

using, if there is second router identification information identical to the first router identification information, at least one second application account bound to the second router identification information identical to the first router identification information as the obtained at least one second application account bound to the first router identification information.

Preferably, after the determining whether there is second router identification information identical to the first router identification information in the at least one piece of second router identification information, the method further includes:

determining, if there is no second router identification information identical to the first router identification information in the at least one piece of second router identification information, that the at least one second application account bound to the first router identification information is not obtained.

Preferably, after the determining whether the first application account is an application account managed by the at least one second application account bound to the first router identification information, the method further includes:

determining that the terminal does not have permission to connect to the network through the router, if it is determined that the first application account is not an application account managed by the at least one second application account bound to the first router identification information.

Preferably, after the determining whether the first application account is an application account managed by the at least one second application account bound to the first router identification information, the method further includes:

determining whether the first application account can be added as an application account managed by the at least one second application account bound to the first router identification information, if it is determined that the first application account is not an application account managed by the at least one second application account bound to the first router identification information; and

adding, if it is determined that the first application account can be added as an application account managed by the at least one second application account bound to the first router identification information, the first application account as an application account managed by the at least one second application account bound to the first router identification information, and determining that the terminal has permission to connect to the network through the router.

Preferably, after the determining whether the first application account can be added as an application account managed by the at least one second application account bound to the first router identification information, the method further includes:

determining that the terminal does not have permission to connect to the network through the router, if it is determined that the first application account cannot be added as an application account managed by the at least one second application account bound to the first router identification information.

203: Return, to the terminal if it is determined that the terminal has permission to connect to the network through the router, authentication information of connecting to the network through the router, so that the terminal connects to the network through the router according to the authentication information after receiving the authentication information.

Preferably, the returning, to the terminal, authentication information of connecting to the network through the router includes:

receiving and storing authentication information submitted by the router, and returning, to the terminal, the pre-stored authentication information of connecting to the network through the router.

Preferably, the returning, to the terminal, authentication information of connecting to the network through the router includes:

instructing the router to return, to the terminal, authentication information of connecting to the network, and returning, to the terminal through the router, authentication information of connecting to the network through the router.

Preferably, before the returning, to the terminal, authentication information of connecting to the network through the router, the method further includes:

sending, to the router, network connection permission range information for limiting connection of the terminal to the network through the router, so that the router controls a network connection range of the terminal according to the network connection permission range information.

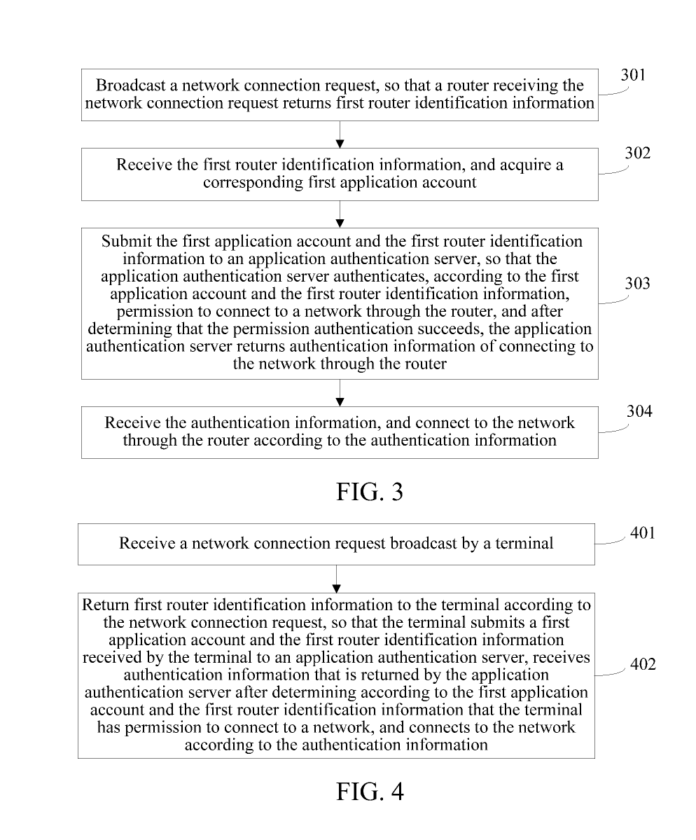

For an example in which the method provided by this embodiment of the present invention is executed by a terminal, referring to FIG. 3, the process of the method provided by this embodiment of the present invention includes:

301: Broadcast a network connection request, so that a router receiving the network connection request returns first router identification information.

302: Receive the first router identification information, and acquire a corresponding first application account.

303: Submit the first application account and the first router identification information to an application authentication server, so that the application authentication server authenticates, according to the first application account and the first router identification information, permission to connect to a network through the router, and after determining that the permission authentication succeeds, the application authentication server returns authentication information of connecting to the network through the router.

304: Receive the authentication information, and connect to the network through the router according to the authentication information.

Preferably, the receiving the authentication information includes:

receiving the authentication information of connecting to the network through the router that is returned by the application authentication server, the authentication information being pre-stored by the application authentication server.

Preferably, the receiving the authentication information includes:

receiving authentication information of connecting to the network through the router that is returned by the router, the authentication information being sent by the router after receiving a notification sent from the application authentication server.

For an example in which the method provided by this embodiment of the present invention is executed by a router, referring to FIG. 4, the process of the method provided by this embodiment of the present invention includes:

401: Receive a network connection request broadcast by a terminal.

402: Return first router identification information to the terminal according to the network connection request, so that the terminal submits a first application account and the first router identification information received by the terminal to an application authentication server, receives authentication information that is returned by the application authentication server after determining according to the first application account and the first router identification information that the terminal has permission to connect to a network, and connects to the network according to the authentication information.

Preferably, the method further includes:

submitting the first router identification information to the application authentication server, so that after binding the first router identification information to at least one second application account, the application authentication server determines according to the at least one second application account bound to the first router identification information whether the terminal has permission to connect to the network.

Preferably, before the receiving a network connection request broadcast by a terminal, the method further includes:

submitting, to the application authentication server, authentication information of connecting to the network, so that after determining that the terminal has permission to connect to the network, the application authentication server returns the authentication information to the terminal, and the terminal receives the authentication information and connects to the network according to the authentication information.

Preferably, the method further includes:

receiving a notification message sent by the application authentication server, and returning, to the terminal according to the notification message, pre-stored authentication information of connecting to the network.

Preferably, the method further includes:

receiving network connection permission range information for limiting connection of the terminal to the network that is sent by the application authentication server; and

controlling a network connection range of the terminal according to the network connection permission range information.

In the method provided by this embodiment of the present invention, after it is determined, according to a first application account corresponding to a terminal and first router identification information received by the terminal, that the terminal has permission to connect to a network through a router, authentication information of connecting to the network through the router is directly returned to the terminal, so that the terminal can connect to the network according to the authentication information without the need for the user to input authentication information. This not only simplifies the network connection operation of the terminal, but also can improve the network connection efficiency of the terminal.

### Embodiment 2

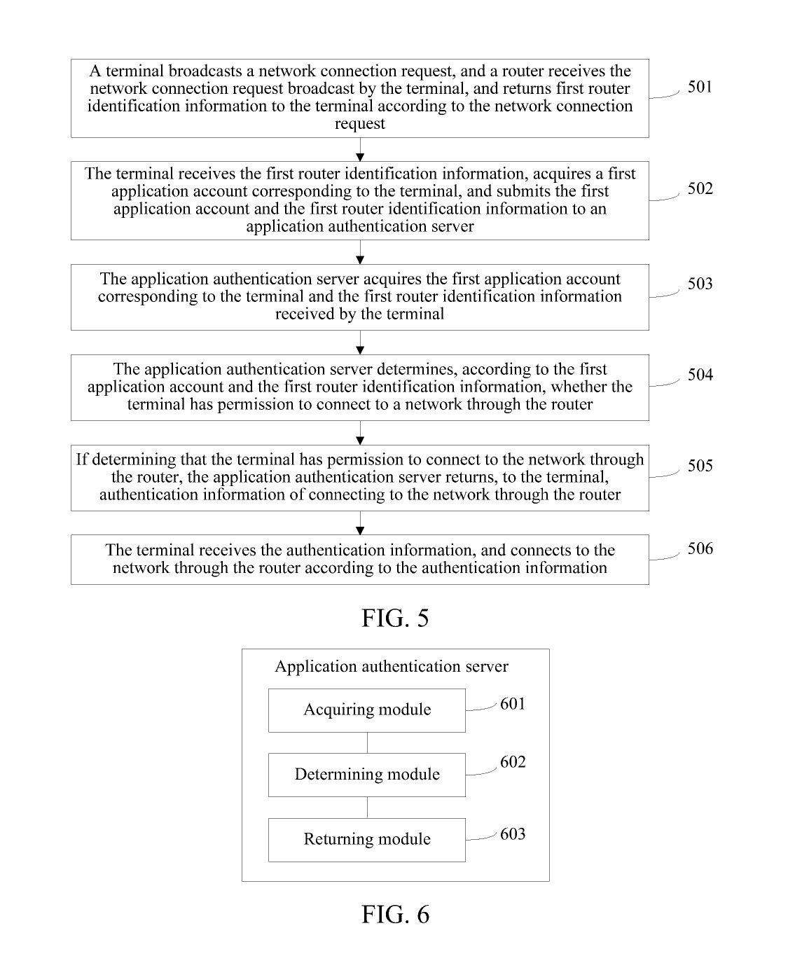

With reference to the implementation environment shown in FIG. 1 and the content of Embodiment 1, this embodiment of the present invention provides a network connection method. Referring to FIG. 5, the process of the method provided by this embodiment of the present invention includes:

501: A terminal broadcasts a network connection request, and a router receives the network connection request broadcast by the terminal, and returns first router identification information to the terminal according to the network connection request.

In order to trigger connection to a network through the router, the terminal needs to broadcast a network connection request. When the terminal connects to a network through a router, the terminal needs to acquire router identification information of a router and authentication information corresponding to the router identification information; therefore, after a router that can provide a network connection service for the terminal receives the network connection request broadcast by the terminal, the router returns the router identification information to the terminal according to the network connection request. For the convenience of description, in this embodiment of the present invention, the router identification information returned to the terminal by the router that provides the current network connection service for the terminal is referred to as first router identification information.

The manner in which the terminal broadcasts the network connection request is not specifically limited in this embodiment of the present invention. For example, when the terminal needs to connect to a wireless network, the terminal may enable a wireless communication interface to broadcast the network connection request. The manner in which the router receives the network connection request broadcast by the terminal and the manner in which the router returns the first router identification information to the terminal according to the network connection request also are not specifically limited in this embodiment of the present invention. When returning the first router identification information to the terminal according to the network connection request, the router may first acquire, after receiving the network connection request, router identification information set by the user from stored configuration information, the obtained router identification information being the first router identification information of the router, and then return, to the terminal, the first router identification information obtained from the configuration information.

502: The terminal receives the first router identification information, acquires a first application account corresponding to the terminal, and submits the first application account and the first router identification information to an application authentication server.

To enable the application authentication server to determine, according to the first application account corresponding to the terminal and the first router identification information received by the terminal, whether the terminal has permission to connect to the network through the router corresponding to the received first router identification information, the terminal may receive the first router identification information, acquire the first application account corresponding to the terminal, and submit the first application account and the first router identification information to the application authentication server.

The manner in which the terminal receives the first router identification information is not specifically limited in this embodiment of the present invention. If the terminal simultaneously receives a plurality of pieces of first router identification information returned by a plurality of routers, the terminal may determine, according to signal strength of the received plurality of pieces of first router identification information, to use which router to connect to the network. Generally, the terminal chooses to use the router with the strongest signal strength to connect to the network.

In addition, there may be multiple manners for the terminal to acquire the first application account corresponding to the terminal. For example, the terminal may start an application that is already configured, and acquire the first application account corresponding to the terminal from the application; or the terminal may be provided with a network connection interface for acquiring an application account, and the terminal may acquire the first application account corresponding to the terminal by detecting an application account that is input into the network connection interface by the user. The type of the first application account is not specifically limited in this embodiment of the present invention. In order to enable the application authentication server to determine in subsequent processes, according to the first application account corresponding to the terminal and the first router identification information received by the terminal, whether the terminal has permission to connect to the network through the router corresponding to the first router identification information, the application corresponding to the first application account and the application corresponding to the application authentication server should be a same application, so that the authentication server can identify the first application account and provide the authentication service. Therefore, the first application account corresponding to the terminal should be an account of the same type as the application account that is used by the application authentication server to determine whether the terminal has permission to connect to the network through the router.

There may also be multiple manners for the terminal to submit the first application account and the first router identification information to the application authentication server. For example, the terminal may log in to a corresponding application by using the first application account, interact with an authentication server of the application corresponding to the first application account, and send interaction information including the first router identification information to the application authentication server during interaction; or the terminal may also acquire the first application account and the first router identification information that are input into the displayed network connection interface by the user, and submit the network connection interface carrying the first application account and the first router identification information to the application authentication server. Definitely, the terminal may also submit the first application account and the first router identification information to the application authentication server in other manners, which are not specifically limited in this embodiment of the present invention.

503: The application authentication server acquires the first application account corresponding to the terminal and the first router identification information received by the terminal.

The manner in which the application authentication server acquires the first application account corresponding to the terminal and the first router identification information received by the terminal is not specifically limited in this embodiment of the present invention. For example, if the terminal logs in to an application by using the first application account, interacts with the application authentication server by means of the application, and sends interaction information including the first router identification information to the application authentication server during interaction, the application authentication server may acquire, from the interaction information sent by the terminal, the first application account corresponding to the terminal and the first router identification information received by the terminal.

504: The application authentication server determines, according to the first application account and the first router identification information, whether the terminal has permission to connect to a network through the router.

To enable the application authentication server to determine according to a certain criterion whether the terminal has permission to connect to the network through the router corresponding to the first router identification information received by the terminal, the application authentication server may further bind at least one piece of second router identification information to at least one second application account before determining, according to the first application account and the first router identification information, whether the terminal has permission to connect to the network through the router.

Before binding the at least one piece of second router identification information to the at least one second application account, the application authentication server needs to separately acquire the at least one piece of second router identification information and the at least one second application account. There may be multiple manners for the application authentication server to acquire the at least one piece of second router identification information. For example, after the administrator of each router sets router identification information of the router, the router stores the router identification information and submits the router identification information to the application authentication server, and the application authentication server acquires the at least one piece of second router identification information by receiving the router identification information submitted by at least one router. In addition, the manner in which the application authentication server acquires the at least one second application account may be that: after the administrator of each router sets the router identification information of the router, when the router submits the router identification information to the application authentication server, the application authentication server displays a pop-up interface for acquiring a second application account of the administrator, and the administrator inputs at least one corresponding second application account into the corresponding interface, so that the application authentication server acquires the at least one second application account; or the administrator of the router may log in to a management system by using an administrator account, and input corresponding second router identification information and at least one corresponding second application account into the management system.

Preferably, after the application authentication server successfully binds the at least one piece of second router identification information to the at least one second application account, the application authentication server may send a successful binding message to at least one router corresponding to the bound at least one piece of second router identification information, so that after receiving the successful binding message, the router may return, upon receiving the network connection request broadcast by the terminal, the router identification information corresponding to the router to the terminal, and subsequently further cooperate with the application authentication server to complete the network connection method provided by this embodiment of the present invention.

Further, after binding the at least one piece of second router identification information to the at least one second application account, the application authentication server stores a binding relation between the at least one piece of second router identification information and the at least one second application account, and thus can subsequently determine according to the binding relation whether the terminal has permission to connect to the network through the router corresponding to the received first router identification information. The binding relation between the at least one piece of second router identification information and the at least one second application account that is stored by the application authentication server may be shown in Table 1:

TABLE 1

| Second router | Second | |
|---|---|---|
| identification | application | Second application |
| information | account (1) | account (2) |
| Router identification | 78975 | 75834 |
| information A | | |
| Router identification | 28378 | None |
| information B | | |

The binding, by the application authentication server, the at least one piece of second router identification information to the at least one second application account, and determining, according to the first application account and the first router identification information, whether the terminal has permission to connect to the network through the router may be, but not limited to, implemented by performing the following steps:

First step: The application authentication server acquires at least one second application account bound to the first router identification information.

The acquiring, by the application authentication server, at least one second application account bound to the first router identification information may be, but not limited to, implemented in the following manner:

determining, by the application authentication server, whether there is second router identification information identical to the first router identification information in the at least one piece of second router identification information; and if the application authentication server determines that there is second router identification information identical to the first router identification information in the at least one piece of second router identification information, using at least one second application account bound to the second router identification information identical to the first router identification information as the obtained at least one second application account bound to the first router identification information; or if the application authentication server determines that there is no second router identification information identical to the first router identification information in the at least one piece of second router identification information, determining that the at least one second application account bound to the first router identification information is not obtained.

For example, the first router identification information received by the terminal is router identification information B, and the at least one piece of second router identification information currently already bound by the application authentication server is shown in Table 1, that is, the at least one piece of second router identification information currently bound by the application authentication server includes router identification information A and the router identification information B. In this case, the application authentication server compares the received first router identification information, that is, the router identification information B, with the router identification information A and the router identification information B that are already bound, and thus determines that the router identification information A and the router identification information B that are already bound include identification information identical to the first router identification information, that is, the router identification information B. In this case, the application authentication server uses at least one second application account bound to the router identification information B as the obtained at least one second application account bound to the first router identification information. However, if the first router identification information received by the terminal is router identification information C, because the at least one piece of second router identification information currently bound by the application authentication server does not include router identification information identical to the router identification information C, the application authentication server determines that the at least one second application account bound to the first router identification information is not obtained.

Second step: Determine, if the application authentication server obtains at least one second application account bound to the first router identification information, whether the first application account is an application account managed by the at least one second application account bound to the first router identification information.

The manner in which the application authentication server determines whether the first application account is an application account managed by the at least one second application account bound to the first router identification information is not specifically limited in this embodiment of the present invention. In a specific implementation, after obtaining at least one second application account bound to the first router identification information, the application authentication server may continue to acquire all application accounts managed by the at least one second application account bound to the first router identification information, and compare the first application account with all the application accounts managed by the at least one second application account one by one. If the first application account exists in all the application accounts managed by the at least one second application account, it is determined that the first application account is an application account managed by the at least one second application account bound to the first router identification information; otherwise, it is determined that the first application account is not an application account managed by the at least one second application account bound to the first router identification information.

For example, the at least one second application account bound to the first router identification information that is obtained by the application authentication server is 23875, accounts managed by the second application account are 34875, 74875 and so on, and the first application account is 34875. In this case, the application authentication server determines that the first application account is an application account managed by the at least one second application account bound to the first router identification information.

Third step: Determine that the terminal has permission to connect to the network through the router, if the application authentication server determines that the first application account is an application account managed by the at least one second application account bound to the first router identification information; or determine that the terminal does not have permission to connect to the network through the router, if the application authentication server determines that the first application account is not an application account managed by the at least one second application account bound to the first router identification information.

It should be noted that if the application authentication server determines in the first step that the at least one second application account bound to the first router identification information is not obtained, the application authentication server also determines that the terminal does not have permission to connect to the network through the router.

For the convenience of description, the application authentication server determining according to the first application account and the first router identification information whether the terminal has permission to connect to the network through the router is described below through a specific example.

For example, the at least one piece of second router identification information currently already bound by the application authentication server is shown in Table 1, that is, the at least one piece of second router identification information that is currently bound includes the router identification information A and the router identification information B; and the first router identification information is the router identification information A, the second application accounts bound to the router identification information A that is stored by the application authentication server are 78975 and 75834, application accounts managed by 78975 are 38765 and 46583, and the first application account is 46583. In this case, because there is router identification information identical to the router identification information A in the at least one piece of second router identification information currently already bound by the application authentication server, and the first application account 46583 is an application account managed by the second application account 78975 bound to the router identification information A, the application authentication server determines that the terminal has permission to connect to the network through the router.

By determining whether the first application account corresponding to the terminal is an application account managed by the at least one second application account bound to the at least one piece of second router identification information, the application authentication server determines whether the terminal has permission to connect to the network through the router, so as to ensure that only when the first application account corresponding to the terminal is an application account managed by the at least one second application account bound to the at least one piece of second router identification information, the terminal can connect to the network through the router. In this way, the number of terminals that connect to the network through the router can be limited, so that the number of terminals that connect to the network through the router is determined by the number of application accounts managed by the at least one second application account bound to the router identification information of the router.

On the basis of the above, when determining, according to the first application account corresponding to the terminal and the first router identification information received by the terminal, whether the terminal has permission to connect to the network through the router corresponding to the first router identification information, the application authentication server makes a determination according to an association between the corresponding first application account and at least one second application account bound to the first router identification information, so as to ensure that the terminal corresponding to the first application account associated with the at least one second application account bound to the first router identification information has permission to connect to the network through the router corresponding to the first router identification information.

Preferably, if the application authentication server determines that the first application account is not an application account managed by the at least one second application account bound to the first router identification information, the application authentication server determines that the terminal does not have permission to connect to the network, and accordingly, the terminal cannot connect to the network through the router. In this case, to enable the terminal to connect to the network, the application authentication server may further determine whether the first application account can be added as an application account managed by the at least one second application account bound to the first router identification information; and if determining that the first application account can be added as an application account managed by the at least one second application account bound to the first router identification information, add the first application account as an application account managed by the at least one second application account bound to the first router identification information, and determine that the terminal has permission to connect to the network through the router.

The manner in which the application authentication server determines whether the first application account can be added as an application account managed by the at least one second application account bound to the first router identification information is not specifically limited in this embodiment of the present invention. In a specific implementation, the application authentication server may provide a checkbox for temporarily adding a first application account, and when detecting that the checkbox is checked, the application authentication server determines that another first application account can be temporarily added as an application account managed by the at least one second application account. Therefore, after the application authentication server temporarily adds a first application account, the added first application account becomes an application account managed by the second application account. In this case, the terminal corresponding to the first application account has permission to connect to the network through the router corresponding to the first router identification information.

Further, if the application authentication server determines that the first application account cannot be added as an application account managed by the at least one second application account bound to the first router identification information, the application authentication server determines that the terminal does not have permission to connect to the network through the router.

Preferably, after the application authentication server determines that the terminal does not have permission to connect to the network through the router, to enable a corresponding user of the terminal to know that it is not allowed to connect to the network through the router corresponding to the first router identification information at this moment, the application authentication server may further return a network connection failure response to the terminal. After receiving the network connection failure response, the terminal may display a message prompting the network connection failure, so that the corresponding user of the terminal can determine that the current network connection fails.

505: If determining that the terminal has permission to connect to the network through the router, the application authentication server returns, to the terminal, authentication information of connecting to the network through the router.

When connecting to the network through the router, the terminal needs to acquire authentication information of connecting to the network through the router. In this embodiment of the present invention, after the application authentication server determines that the terminal has permission to connect to the network through the router, the application authentication server returns, to the terminal, the authentication information of connecting to the network through the router, so that the terminal acquires the authentication information of connecting to the network through the router. The manner in which the application authentication server returns, to the terminal, the authentication information of connecting to the network through the router includes, but is not limited to, the following two manners:

First manner: The application authentication server receives and stores authentication information submitted by the router, and returns, to the terminal, the pre-stored authentication information of connecting to the network through the router.

In this manner, after the administrator of the router sets the authentication information of the router, the router stores the authentication information and submits the authentication information to the application authentication server, and the application authentication server receives and stores the authentication information submitted by the router. Therefore, when the application authentication server determines that the terminal has permission to connect to the network through the router, the application authentication server may directly return, to the terminal, the pre-stored authentication information of connecting to the network through the router. The manner in which the application authentication server receives and stores the router the authentication information submitted by the router and the manner in which the application authentication server returns, to the terminal, the pre-stored authentication information of connecting to the network through the router is not specifically limited in this embodiment of the present invention.

Second manner: The application authentication server instructs the router to return, to the terminal, authentication information of connecting to the network, and returns, to the terminal through the router, authentication information of connecting to the network through the router.

In this manner, after the administrator of the router sets the authentication information of the router, the router stores the authentication information and does not submit the authentication information to the application authentication server. After the application authentication server determines that the terminal has permission to connect to the network through the router, the application authentication server may instruct the router to return, to the terminal, authentication information of connecting to the network, and return, to the terminal through the router, authentication information of connecting to the network through the router. There may be multiple manners for the application authentication server to instruct the router to return, to the terminal, authentication information of connecting to the network. For example, the application authentication server may instruct, by sending a notification message, the router to return, to the terminal, authentication information of connecting to the network, or may instruct, by sending an instruction, the router to return, to the terminal, authentication information of connecting to the network, and so on.

The type of the authentication information of connecting to the network through the router is not specifically limited in this embodiment of the present invention. In a specific implementation, the type of the authentication information of connecting to the network through the router includes, but is not limited to, PSK information of the router or portal address information of the router.

506: The terminal receives the authentication information, and connects to the network through the router according to the authentication information.

The manner in which the terminal receives the authentication information is not specifically limited in this embodiment of the present invention. The manner in which the terminal connects to the network through the router according to the authentication information varies with the type of the authentication information of connecting to the network through the router. For example, if the type of the authentication information of connecting to the network through the router is PSK information of the router, the terminal connects to the network according to the PSK information of the router; if the type of the authentication information of connecting to the network through the router is portal address information of the router, the terminal connects to the network through the router according to the portal address information of the router.

Preferably, to limit the use of the network by the terminal after connecting to the network, before returning, to the terminal, the authentication information of connecting to the network through the router, the application authentication server may further send, to the router, network connection permission range information for limiting connection of the terminal to the network through the router, so that the router controls the network connection range of the terminal according to the network connection permission range information.

The specific content of the network connection permission range information sent by the application authentication server to the router is not specifically limited in this embodiment of the present invention. For example, the network connection permission range information may include time information for limiting connection of the terminal to the network through the router, or may include traffic information for limiting connection of the terminal to the network through the router, or may include network resource type information for limiting connection of the terminal to the network through the router, and so on. The network resource type information for limiting connection of the terminal to the network through the router may include, but is not limited to, video type information, audio type information, webpage type, and the like.

When the network connection permission range information includes the time information for limiting connection of the terminal to the network through the router, the router can control the time for the terminal to connect to the network through the router, so that the terminal can connect to the network through the router only in a time interval corresponding to the time information for network connection. When the network connection permission range information includes the traffic information for limiting connection of the terminal to the network through the router, the router can control traffic of the terminal connecting to the network through the router, so that the terminal can only access network resources of the traffic corresponding to the traffic information for network connection. When the network connection permission range information includes the network resource type information for limiting connection of the terminal to the network through the router, the router can control the type of network resources in the network accessed by the terminal through the router. For example, if the network resource type information only includes the webpage resource type, the terminal, after connecting to the network through the router, can only access network resources of the webpage type, and cannot access network resources of other types such as video and audio.

Further, after the application authentication server sends, to the router, the network connection permission range information for limiting connection of the terminal to the network through the router, the router may also forward the network connection permission range information to the terminal. After receiving the network connection permission range information, the terminal can enable the corresponding user of the terminal to determine, according to the network connection permission range information, which network resources can be accessed and which network resources cannot be accessed, thereby further controlling the terminal to access network resources that match the network connection permission range information. The manner in which the router forwards the network connection permission range information to the terminal and the manner in which the terminal receives the network connection permission range information are not specifically limited in this embodiment of the present invention.

In the method provided by this embodiment of the present invention, after it is determined, according to a first application account corresponding to a terminal and first router identification information received by the terminal, that the terminal has permission to connect to a network through a router, authentication information of connecting to the network through the router is directly returned to the terminal, so that the terminal can connect to the network according to the authentication information without the need for the user to input authentication information. This not only simplifies the network connection operation of the terminal, but also can improve the network connection efficiency of the terminal.

### Embodiment 3

This embodiment of the present invention provides an application authentication server, which is used for performing the functions that are performed by the application authentication server in the foregoing Embodiment 1 or Embodiment 2. Referring to FIG. 6, the application authentication server includes:

an acquiring module 601, configured to acquire a first application account corresponding to a terminal and first router identification information received by the terminal, the first router identification information being sent by a router corresponding to the first router identification information;

a determining module 602, configured to determine, according to the first application account and the first router identification information, whether the terminal has permission to connect to a network through the router; and

a returning module 603, configured to return, to the terminal when it is determined that the terminal has permission to connect to the network through the router, authentication information of connecting to the network through the router, so that the terminal connects to the network through the router according to the authentication information after receiving the authentication information.

Preferably, the determining module 602 includes:

an acquiring unit, configured to acquire at least one second application account bound to the first router identification information;

a first determining unit, configured to determine, when at least one second application account bound to the first router identification information is obtained, whether the first application account is an application account managed by the at least one second application account bound to the first router identification information; and

a second determining unit, configured to determine that the terminal has permission to connect to the network through the router, when it is determined that the first application account is an application account managed by the at least one second application account bound to the first router identification information.

Preferably, the application authentication server further includes:

a binding module, configured to bind at least one piece of second router identification information to at least one second application account; and

the acquiring unit includes:

a first determining subunit, configured to determine whether there is second router identification information identical to the first router identification information in the at least one piece of second router identification information; and

a second determining subunit, configured to use, when there is second router identification information identical to the first router identification information, at least one second application account bound to the second router identification information identical to the first router identification information as the obtained at least one second application account bound to the first router identification information.

Preferably, the acquiring unit includes:

a third determining subunit, configured to determine, when there is no second router identification information identical to the first router identification information in the at least one piece of second router identification information, that the at least one second application account bound to the first router identification information is not obtained.

Preferably, the determining module 602 includes:

a third determining unit, configured to determine that the terminal does not have permission to connect to the network through the router, when it is determined that the first application account is not an application account managed by the at least one second application account bound to the first router identification information.

Preferably, the determining module 602 further includes:

a fourth determining unit, configured to determine whether the first application account can be added as an application account managed by the at least one second application account bound to the first router identification information, when it is determined that the first application account is not an application account managed by the at least one second application account bound to the first router identification information; and

an adding unit, configured to add, when it is determined that the first application account can be added as an application account managed by the at least one second application account bound to the first router identification information, the first application account as an application account managed by the at least one second application account bound to the first router identification information, and determine that the terminal has permission to connect to the network through the router.

Preferably, the determining module 602 further includes:

a fifth determining unit, configured to determine that the terminal does not have permission to connect to the network through the router, when it is determined that the first application account cannot be added as an application account managed by the at least one second application account bound to the first router identification information.

Preferably, the returning module 603 includes:

a receiving unit, configured to receive and store authentication information submitted by the router;

a returning unit, configured to return, to the terminal, the pre-stored authentication information of connecting to the network through the router.

Preferably, the returning module 603 includes:

a notification unit, configured to instruct the router to return, to the terminal, authentication information of connecting to the network, and return, to the terminal through the router, authentication information of connecting to the network through the router.

Preferably, the application authentication server further includes:

a sending module, configured to send, to the router, network connection permission range information for limiting connection of the terminal to the network through the router, so that the router controls a network connection range of the terminal according to the network connection permission range information.

After determining, according to a first application account corresponding to a terminal and first router identification information received by the terminal, that the terminal has permission to connect to a network through a router, the application authentication server provided by this embodiment of the present invention directly returns authentication information of connecting to the network through the router to the terminal, so that the terminal can connect to the network according to the authentication information without the need for the user to input authentication information. This not only simplifies the network connection operation of the terminal, but also can improve the network connection efficiency of the terminal.

### Embodiment 4

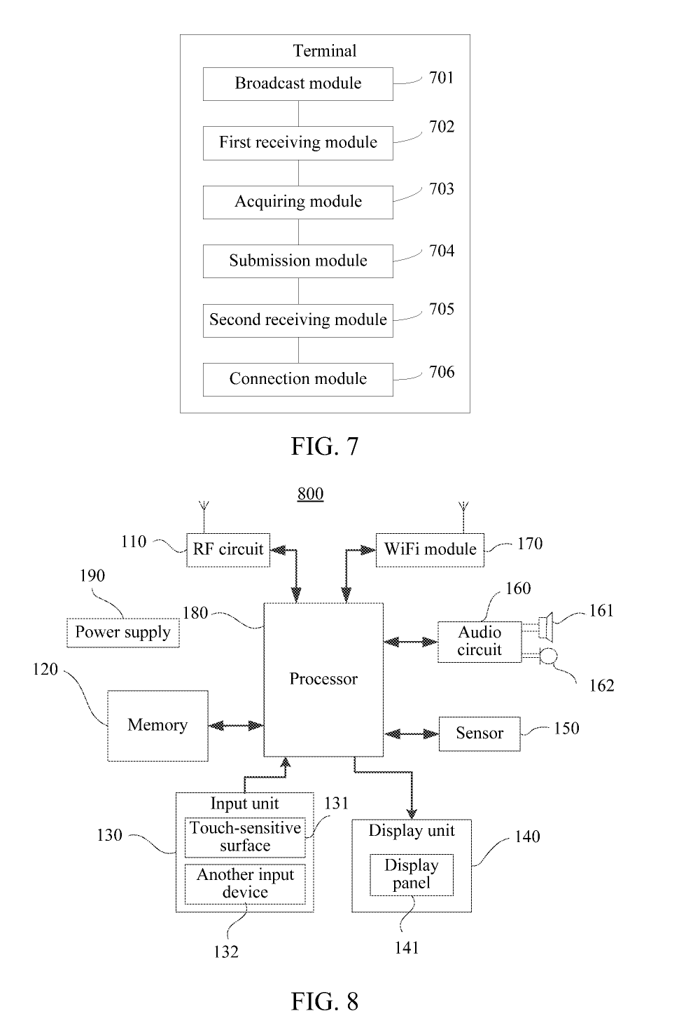

This embodiment of the present invention provides a terminal, which is used for performing the functions that are performed by the terminal in the foregoing Embodiment 1 or Embodiment 2. Referring to FIG. 7, the terminal includes:

a broadcast module 701, configured to broadcast a network connection request, so that a router receiving the network connection request returns first router identification information;

a first receiving module 702, configured to receive the first router identification information;

an acquiring module 703, configured to acquire a corresponding first application account;

a submission module 704, configured to submit the first application account and the first router identification information to an application authentication server, so that the application authentication server authenticates, according to the first application account and the first router identification information, permission to connect to a network through the router, and after determining that the permission authentication succeeds, the application authentication server returns authentication information of connecting to the network through the router; and

a second receiving module 705, configured to receive the authentication information; and

a connection module 706, configured to connect to the network through the router according to the authentication information.

Preferably, the second receiving module 705 is configured to receive the authentication information of connecting to the network through the router that is returned by the application authentication server, the authentication information being pre-stored by the application authentication server.

Preferably, the second receiving module 705 is configured to receive authentication information of connecting to the network through the router that is returned by the router, the authentication information being sent by the router after receiving a notification sent from the application authentication server.

The terminal provided by this embodiment of the present invention submits a corresponding first application account and received first router identification information to an application authentication server, and after determining, according to the first application account corresponding to the terminal and the first router identification information received by the terminal, that the terminal has permission to connect to the network through the router, the application authentication server directly returns authentication information of connecting to the network through the router to the terminal, so that the terminal can connect to the network according to the authentication information without the need for the user to input authentication information. This not only simplifies the network connection operation of the terminal, but also can improve the network connection efficiency of the terminal.

### Embodiment 5

FIG. 8 is a schematic structural diagram of a terminal involved in an embodiment of the present invention. The terminal may be used to implement the methods provided in the foregoing embodiments. Specifically,

The terminal 800 may include components such as a radio frequency (RF) circuit 110, a memory 120 including one or more computer readable storage media, an input unit 130, a display unit 140, a sensor 150, an audio circuit 160, a WiFi module 170, a processor 180, and a power supply 190. A person skilled in the art may understand that the structure of the terminal shown in FIG. 8 does not constitute a limitation to the terminal, and the terminal may include more components or fewer components than those shown in the figure, or some components may be combined, or a different component deployment may be used.

The RF circuit 110 may be configured to receive and send signals during an information receiving and sending process or a call process. Particularly, the RF circuit 110 receives downlink information from a base station, then delivers the downlink information to the processor 180 for processing, and sends related uplink data to the base station. Generally, the RF circuit 100 includes, but is not limited to, an antenna, at least one amplifier, a tuner, one or more oscillators, a subscriber identity module (SIM), a transceiver, a coupler, a low noise amplifier (LNA), and a duplexer. In addition, the RF circuit 110 may also communicate with a network and another device by wireless communication. The wireless communication may use any communications standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the terminal 800, and the like. In addition, the memory 120 may include a high speed random access memory, and may also include a non-volatile memory such as at least one magnetic disk storage device, a flash memory, or another volatile solid-state storage device. Correspondingly, the memory 120 may further include a memory controller, so as to provide access of the processor 180 and the input unit 130 to the memory 120.

The input unit 130 may be configured to receive input digit or character information, and generate a keyboard, mouse, joystick, optical, or track ball signal input related to the user setting and function control. Specifically, the input unit 130 may include a touch-sensitive surface 131 and another input device 132. The touch-sensitive surface 131, which may also be referred to as a touch screen or a touch panel, may collect a touch operation of a user on or near the touch-sensitive surface (such as an operation of a user on or near the touch-sensitive surface 131 by using any suitable object or accessory, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch signal from the touch detection apparatus, converts the touch signal into touch point coordinates, and sends the touch point coordinates to the processor 180. Moreover, the touch controller can receive and execute a command sent from the processor 180. In addition, the touch-sensitive surface 131 may be may be a resistive, capacitive, infrared, or surface sound wave type touch-sensitive surface. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the user or information provided for the user, and various graphical user interfaces of the terminal 800. The graphical user interfaces may be formed by a graph, a text, an icon, a video, or any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine the type of the touch event. Then, the processor 180 provides a corresponding visual output on the display panel 141 according to the type of the touch event. Although the touch-sensitive surface 131 and the display panel 141 in FIG. 8 are configured as two separate parts to implement input and output functions, in some embodiments, the touch-sensitive surface 131 and the display panel 141 may be integrated to implement the input and output functions.

The terminal 800 may further include at least one sensor 150, such as an optical sensor, a motion sensor, and other sensors. Specifically, the optical sensor may include an ambient light sensor and a proximity sensor. The ambient light sensor can adjust luminance of the display panel 141 according to brightness of the ambient light. The proximity sensor may switch off the display panel 141 and/or backlight when the terminal 800 is moved to the ear. As one type of motion sensor, a gravity acceleration sensor can detect magnitude of accelerations in various directions (generally on three axes), may detect magnitude and a direction of the gravity when static, and may be applied to an application that recognizes the attitude of the terminal (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the terminal 800, are not further described herein.

The audio circuit 160, a loudspeaker 161, and a microphone 162 may provide audio interfaces between the user and the terminal 800. The audio circuit 160 may convert received audio data into an electric signal and transmit the electric signal to the loudspeaker 161. The loudspeaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, so as to provide communication between a peripheral earphone and the terminal 800.

WiFi is a short distance wireless transmission technology. The terminal 800 may help, by using the WiFi module 170, the user to receive and send e-mails, browse a webpage, access streaming media, and so on, which provides wireless broadband Internet access for the user. Although FIG. 8 shows the WiFi module 170, it may be understood that the WiFi module is not a necessary component of the terminal 800, and when required, the WiFi module may be omitted as long as the scope of the essence of the present disclosure is not changed.

The processor 180 is the control center of the terminal 800, and is connected to various parts of the terminal by using various interfaces and lines. By running or executing the software program and/or module stored in the memory 120, and invoking data stored in the memory 120, the processor 180 performs various functions and data processing of the terminal 800, thereby performing overall monitoring on the terminal. Optionally, the processor 180 may include one or more processing cores. Preferably, the processor 180 may integrate an application processor and a modem. The application processor mainly processes an operating system, a user interface, an application program, and the like. The modem mainly processes wireless communication. It may be understood that the foregoing modem may also not be integrated into the processor 180.

The terminal 800 further includes the power supply 190 (such as a battery) for supplying power to the components. Preferably, the power supply may be logically connected to the processor 180 by using a power management system, thereby implementing functions such as charging, discharging and power consumption management by using the power management system. The power supply 190 may further include one or more of a direct current or alternating current power supply, a re-charging system, a power failure detection circuit, a power supply converter or inverter, a power supply state indicator and any other components.

Although not shown in the figure, the terminal 800 may further include a camera, a Bluetooth module, and the like, which are not further described herein. Specifically, in this embodiment, the display unit of the terminal is a touch screen display, and the terminal further includes a memory and one or more programs. The one or more programs are stored in the memory and configured to be executed by one or more processors. The one or more programs contain instructions used for executing the following operations:

broadcasting a network connection request, so that a router receiving the network connection request returns first router identification information;

receiving the first router identification information, and acquiring a corresponding first application account;

submitting the first application account and the first router identification information to an application authentication server, so that the application authentication server authenticates, according to the first application account and the first router identification information, permission to connect to a network through the router, and after determining that the permission authentication succeeds, the application authentication server returns authentication information of connecting to the network through the router; and

receiving the authentication information, and connecting to the network through the router according to the authentication information.

Assuming that the above is a first possible implementation manner, in a second possible implementation manner that is provided on the basis of the first possible implementation manner, the memory of the terminal further contains an instruction for executing the following operation: the receiving the authentication information including:

receiving the authentication information of connecting to the network through the router that is returned by the application authentication server, the authentication information being pre-stored by the application authentication server.

In a third possible implementation manner that is provided on the basis of the first possible implementation manner, the memory of the terminal further contains an instruction for executing the following operation: the receiving the authentication information including:

receiving authentication information of connecting to the network through the router that is returned by the router, the authentication information being sent by the router after receiving a notification sent from the application authentication server.

The terminal provided by this embodiment of the present invention submits a corresponding first application account and received first router identification information to an application authentication server, and after determining, according to the first application account corresponding to the terminal and the first router identification information received by the terminal, that the terminal has permission to connect to the network through the router, the application authentication server directly returns authentication information of connecting to the network through the router to the terminal, so that the terminal can connect to the network according to the authentication information without the need for the user to input authentication information. This not only simplifies the network connection operation of the terminal, but also can improve the network connection efficiency of the terminal.

### Embodiment 6

This embodiment of the present invention provides a computer readable storage medium. The computer readable storage medium may be the computer readable storage medium included in the memory in the foregoing embodiment, or may be an independent computer readable storage medium that is not installed in the terminal. The computer readable storage medium stores one or more programs, the one or more programs being run by one or more processors to execute a network connection method, the method including:

broadcasting a network connection request, so that a router receiving the network connection request returns first router identification information;

receiving the first router identification information, and acquiring a corresponding first application account;

submitting the first application account and the first router identification information to an application authentication server, so that the application authentication server authenticates, according to the first application account and the first router identification information, permission to connect to a network through the router, and after determining that the permission authentication succeeds, the application authentication server returns authentication information of connecting to the network through the router; and

receiving the authentication information, and connecting to the network through the router according to the authentication information.

Assuming that the above is a first possible implementation manner, in a second possible implementation manner that is provided on the basis of the first possible implementation manner, the memory of the terminal further contains an instruction for executing the following operation: the receiving the authentication information including:

receiving the authentication information of connecting to the network through the router that is returned by the application authentication server, the authentication information being pre-stored by the application authentication server.

In a third possible implementation manner that is provided on the basis of the first possible implementation manner, the memory of the terminal further contains an instruction for executing the following operation: the receiving the authentication information including:

receiving authentication information of connecting to the network through the router that is returned by the router, the authentication information being sent by the router after receiving a notification sent from the application authentication server.

According to the computer readable storage medium provided by this embodiment of the present invention, a corresponding first application account and received first router identification information are submitted to an application authentication server, and after determining, according to the first application account corresponding to the terminal and the first router identification information received by the terminal, that the terminal has permission to connect to the network through the router, the application authentication server directly returns authentication information of connecting to the network through the router to the terminal, so that the terminal can connect to the network according to the authentication information without the need for the user to input authentication information. This not only simplifies the network connection operation of the terminal, but also can improve the network connection efficiency of the terminal.

### Embodiment 7

This embodiment of the present invention provides a graphical user interface, which is applied to a terminal, the terminal including a touch screen display, a memory and one or more processors for executing one or more programs. The graphical user interface includes:

broadcasting a network connection request, so that a router receiving the network connection request returns first router identification information;

receiving the first router identification information, and acquiring a corresponding first application account;

submitting the first application account and the first router identification information to an application authentication server, so that the application authentication server authenticates, according to the first application account and the first router identification information, permission to connect to a network through the router, and after determining that the permission authentication succeeds, the application authentication server returns authentication information of connecting to the network through the router; and

receiving the authentication information, and connecting to the network through the router according to the authentication information.

The graphical user interface provided by this embodiment of the present invention submits a corresponding first application account and received first router identification information to an application authentication server, and after determining, according to the first application account corresponding to the terminal and the first router identification information received by the terminal, that the terminal has permission to connect to the network through the router, the application authentication server directly returns authentication information of connecting to the network through the router to the terminal, so that the terminal can connect to the network according to the authentication information without the need for the user to input authentication information. This not only simplifies the network connection operation of the terminal, but also can improve the network connection efficiency of the terminal.

### Embodiment 8

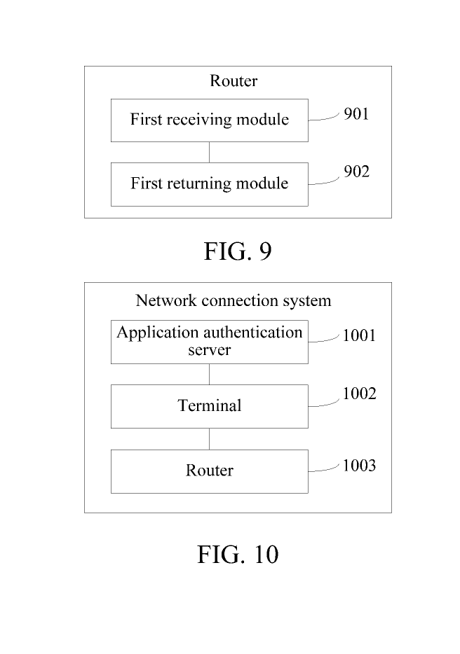

This embodiment of the present invention provides a router, which is used for executing the functions that are executed by the router in the foregoing Embodiment 1 or Embodiment 2. Referring to FIG. 9, the router includes:

a first receiving module 901, configured to receive a network connection request broadcast by a terminal;

a first returning module 902, configured to return first router identification information to the terminal according to the network connection request, so that the terminal submits a first application account and the first router identification information received by the terminal to an application authentication server, receives authentication information that is returned by the application authentication server after determining according to the first application account and the first router identification information that the terminal has permission to connect to a network, and connects to the network according to the authentication information.

Preferably, the router further includes:

a first submission module, configured to submit the first router identification information to the application authentication server, so that after binding the first router identification information to at least one second application account, the application authentication server determines according to the at least one second application account bound to the first router identification information whether the terminal has permission to connect to the network.

Preferably, the router further includes:

a second submission module, configured to submit, to the application authentication server, authentication information of connecting to the network, so that after determining that the terminal has permission to connect to the network, the application authentication server returns the authentication information to the terminal, and the terminal receives the authentication information and connects to the network according to the authentication information.

Preferably, the router further includes:

a second receiving module, configured to receive a notification message sent by the application authentication server; and

a second returning module, configured to return, to the terminal according to the notification message, pre-stored authentication information of connecting to the network.

Preferably, the router further includes:

a third receiving module, configured to receive network connection permission range information for limiting connection of the terminal to the network that is sent by the application authentication server; and

a control module, configured to control a network connection range of the terminal according to the network connection permission range information.

The router provided by this embodiment of the present invention returns corresponding first router identification information to a terminal, the terminal then submits a corresponding first application account and the first router identification information received by the terminal to an application authentication server, and after determining, according to the first application account corresponding to the terminal and the first router identification information received by the terminal, that the terminal has permission to connect to the network through the router, the application authentication server directly returns authentication information of connecting to the network through the router to the terminal, so that the terminal can connect to the network according to the authentication information without the need for the user to input authentication information. This not only simplifies the network connection operation of the terminal, but also can improve the network connection efficiency of the terminal.

### Embodiment 9

This embodiment of the present invention provides a network connection system. Referring to FIG. 10, the system includes: an application authentication server 1001, a terminal 1002 and a router 1003.

The application authentication server 1001 is the application authentication server provided by the foregoing Embodiment 3; refer to the foregoing Embodiment 3 for details, which are not described herein again.

The terminal 1002 is the terminal provided by the foregoing Embodiment 4; refer to the foregoing Embodiment 4 for details, which are not described herein again.

The router 1003 is the router provided by the foregoing Embodiment 8; refer to the foregoing Embodiment 8 for details, which are not described herein again.

In the system provided by this embodiment of the present invention, after it is determined, according to a first application account corresponding to the terminal and first router identification information received by the terminal, that the terminal has permission to connect to a network through the router, authentication information of connecting to the network through the router is directly returned to the terminal, so that the terminal can connect to the network according to the authentication information without the need for the user to input authentication information. This not only simplifies the network connection operation of the terminal, but also can improve the network connection efficiency of the terminal.

It should be noted that the above functional modules are only described for exemplary purposes when the application authentication server, the terminal and the router provided by the foregoing embodiments execute the network connection methods. In actual applications, the functions may be allocated to different functional modules according to specific needs, which means that the internal structure of the apparatus is divided to different functional modules to complete all or some of the above described functions. In addition, the application authentication server, the terminal, the router and the network connection system provided by the foregoing embodiments are based on the same concept as the network connection methods in the foregoing embodiments. For the specific implementation process, refer to the method embodiments, and the details are not described herein again.

The sequence numbers of the foregoing embodiments of the present invention are merely for the convenience of description, and do not imply the preference among the embodiments.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. A network connection method, comprising:
acquiring a first application account corresponding to a terminal and first router identification information received by the terminal, the first router identification information being sent by a router corresponding to the first router identification information;
determining, according to the first application account and the first router identification information, whether the terminal has permission to connect to a network through the router; and
returning, to the terminal if it is determined that the terminal has permission to connect to the network through the router, authentication information of connecting to the network through the router, so that the terminal connects to the network through the router according to the authentication information after receiving the authentication information.

2. The method according to claim 1, wherein the determining, according to the first application account and the first router identification information, whether the terminal has permission to connect to a network through the router comprises:
acquiring at least one second application account bound to the first router identification information;
determining, if at least one second application account bound to the first router identification information is obtained, whether the first application account is an application account managed by the at least one second application account bound to the first router identification information; and
determining that the terminal has permission to connect to the network through the router, if it is determined that the first application account is an application account managed by the at least one second application account bound to the first router identification information.

3. The method according to claim 2, wherein before the acquiring at least one second application account bound to the first router identification information, the method further comprises:
binding at least one piece of second router identification information to at least one second application account; and
the acquiring at least one second application account bound to the first router identification information comprises:
determining whether there is second router identification information identical to the first router identification information in the at least one piece of second router identification information; and
using, if there is second router identification information identical to the first router identification information, at least one second application account bound to the second router identification information identical to the first router identification information as the obtained at least one second application account bound to the first router identification information.

4. The method according to claim 3, wherein after the determining whether there is second router identification information identical to the first router identification information in the at least one piece of second router identification information, the method further comprises:
determining, if there is no second router identification information identical to the first router identification information in the at least one piece of second router identification information, that the at least one second application account bound to the first router identification information is not obtained.

5. The method according to claim 2, wherein after the determining whether the first application account is an application account managed by the at least one second application account bound to the first router identification information, the method further comprises:
determining that the terminal does not have permission to connect to the network through the router, if it is determined that the first application account is not an application account managed by the at least one second application account bound to the first router identification information.

6. The method according to claim 2, wherein after the determining whether the first application account is an application account managed by the at least one second application account bound to the first router identification information, the method further comprises:
determining whether the first application account can be added as an application account managed by the at least one second application account bound to the first router identification information, if it is determined that the first application account is not an application account managed by the at least one second application account bound to the first router identification information; and
adding, if it is determined that the first application account can be added as an application account managed by the at least one second application account bound to the first router identification information, the first application account as an application account managed by the at least one second application account bound to the first router identification information, and determining that the terminal has permission to connect to the network through the router.

7. The method according to claim 6, wherein after the determining whether the first application account can be added as an application account managed by the at least one second application account bound to the first router identification information, the method further comprises:
determining that the terminal does not have permission to connect to the network through the router, if it is determined that the first application account cannot be added as an application account managed by the at least one second application account bound to the first router identification information.

8. A network connection method, comprising:
broadcasting a network connection request, so that a router receiving the network connection request returns first router identification information;
receiving the first router identification information, and acquiring a corresponding first application account;
submitting the first application account and the first router identification information to an application authentication server, so that the application authentication server authenticates, according to the first application account and the first router identification information, permission to connect to a network through the router, and after determining that the permission authentication succeeds, the application authentication server returns authentication information of connecting to the network through the router; and
receiving the authentication information, and connecting to the network through the router according to the authentication information.

9. The method according to claim 8, wherein the receiving the authentication information comprises:
receiving the authentication information of connecting to the network through the router that is returned by the application authentication server, the authentication information being pre-stored by the application authentication server.

10. The method according to claim 8, wherein the receiving the authentication information comprises:
receiving authentication information of connecting to the network through the router that is returned by the router, the authentication information being sent by the router after receiving a notification sent from the application authentication server.

11. A network connection method, comprising:
receiving a network connection request broadcast by a terminal; and
returning first router identification information to the terminal according to the network connection request, so that the terminal submits a first application account and the first router identification information received by the terminal to an application authentication server, receives authentication information that is returned by the application authentication server after determining according to the first application account and the first router identification information that the terminal has permission to connect to a network, and connects to the network according to the authentication information.

12. The method according to claim 11, further comprising:
submitting the first router identification information to the application authentication server, so that after binding the first router identification information to at least one second application account, the application authentication server determines according to the at least one second application account bound to the first router identification information whether the terminal has permission to connect to the network.

13. The method according to claim 11, wherein before the receiving a network connection request broadcast by a terminal, the method further comprises:
submitting, to the application authentication server, authentication information of connecting to the network, so that after determining that the terminal has permission to connect to the network, the application authentication server returns the authentication information to the terminal, and the terminal receives the authentication information and connects to the network according to the authentication information.

14. The method according to claim 11, further comprising:
receiving network connection permission range information for limiting connection of the terminal to the network that is sent by the application authentication server; and
controlling a network connection range of the terminal according to the network connection permission range information.

15. An application authentication server, comprising:
an acquiring module, configured to acquire a first application account corresponding to a terminal and first router identification information received by the terminal, the first router identification information being sent by a router corresponding to the first router identification information;
a determining module, configured to determine, according to the first application account and the first router identification information, whether the terminal has permission to connect to a network through the router; and
a returning module, configured to return, to the terminal when it is determined that the terminal has permission to connect to the network through the router, authentication information of connecting to the network through the router, so that the terminal connects to the network through the router according to the authentication information after receiving the authentication information.

16. The application authentication server according to claim 15, wherein the determining module comprises:
an acquiring unit, configured to acquire at least one second application account bound to the first router identification information;
a first determining unit, configured to determine, when at least one second application account bound to the first router identification information is obtained, whether the first application account is an application account managed by the at least one second application account bound to the first router identification information; and
a second determining unit, configured to determine that the terminal has permission to connect to the network through the router, when it is determined that the first application account is an application account managed by the at least one second application account bound to the first router identification information.

17. The application authentication server according to claim 16, further comprising:
a binding module, configured to bind at least one piece of second router identification information to at least one second application account; and
the acquiring unit comprises:
a first determining subunit, configured to determine whether there is second router identification information identical to the first router identification information in the at least one piece of second router identification information; and
a second determining subunit, configured to use, when there is second router identification information identical to the first router identification information, at least one second application account bound to the second router identification information identical to the first router identification information as the obtained at least one second application account bound to the first router identification information.

18. The application authentication server according to claim 17, wherein the acquiring unit further comprises:
a third determining subunit, configured to determine, when there is no second router identification information identical to the first router identification information in the at least one piece of second router identification information, that the at least one second application account bound to the first router identification information is not obtained.

19. The application authentication server according to claim 16, wherein the determining module further comprises:
a third determining unit, configured to determine that the terminal does not have permission to connect to the network through the router, when it is determined that the first application account is not an application account managed by the at least one second application account bound to the first router identification information.

20. The application authentication server according to claim 16, wherein the determining module further comprises:
a fourth determining unit, configured to determine whether the first application account can be added as an application account managed by the at least one second application account bound to the first router identification information, when it is determined that the first application account is not an application account managed by the at least one second application account bound to the first router identification information; and
an adding unit, configured to add, when it is determined that the first application account can be added as an application account managed by the at least one second application account bound to the first router identification information, the first application account as an application account managed by the at least one second application account bound to the first router identification information, and determine that the terminal has permission to connect to the network through the router.

21. The application authentication server according to claim 20, wherein the determining module further comprises:
a fifth determining unit, configured to determine that the terminal does not have permission to connect to the network through the router, when it is determined that the first application account cannot be added as an application account managed by the at least one second application account bound to the first router identification information.

22. A terminal, comprising:
a broadcast module, configured to broadcast a network connection request, so that a router receiving the network connection request returns first router identification information;
a first receiving module, configured to receive the first router identification information;
an acquiring module, configured to acquire a corresponding first application account;
a submission module, configured to submit the first application account and the first router identification information to an application authentication server, so that the application authentication server authenticates, according to the first application account and the first router identification information, permission to connect to a network through the router, and after determining that the permission authentication succeeds, the application authentication server returns authentication information of connecting to the network through the router; and
a second receiving module, configured to receive the authentication information; and
a connection module, configured to connect to the network through the router according to the authentication information.

23. A router, comprising:
a first receiving module, configured to receive a network connection request broadcast by a terminal; and
a first returning module, configured to return first router identification information to the terminal according to the network connection request, so that the terminal submits a first application account and the first router identification information received by the terminal to an application authentication server, receives authentication information that is returned by the application authentication server after determining according to the first application account and the first router identification information that the terminal has permission to connect to a network, and connects to the network according to the authentication information.
